(19) United States
(12) Patent Application Publication
(10) Pub. No.: US 2009/0326712 A1
(43) Pub. Date: Dec. 31, 2009

(54) CALIBRATION FOR VEHICLE BODY ASSEMBLY

(75) Inventor: Timothy J. Marx, Macomb Township, MI (US)

Correspondence Address: BROOKS KUSHMAN P.C., 1000 TOWN CENTER, TWENTY-SECOND FLOOR, SOUTHFIELD, MI, 48075, US

(73) Assignee: UTICA ENTERPRISES, INC., Shelby Township, MI (US)

(21) Appl. No.: 12/490,479

(22) Filed: Jun. 24, 2009

Related U.S. Application Data
(60) Provisional application No. 61/133,191, filed on Jun. 26, 2008.

(51) Int. Cl. G05B 19/04

(52) U.S. Cl. 700/254

(57) ABSTRACT

A system (10) and method for performing robotic vehicle body assembly with cyclical temperature calibration using laser position sensing.

### CROSS-REFERENCE TO RELATED APPLICATIONS

This application claims the benefit of U.S. provisional application Ser. No. 61/133,191 filed Jun. 26, 2008.

### BACKGROUND OF THE INVENTION

1. Field of the Invention

This invention relates to a system and a method for cyclical robot calibration in connection with vehicle body assembly.

2. Background Art

Robot work position accuracy is affected by heat created during normal operation. The range of deviation (accuracy) from the work position will vary based on a multitude of factors, which include but are not limited to, ambient temperature change, robot manufacturer and type, payload, speed, time of use, etc.

Prior robot compensation has utilized sensors remotely located from the work site and operable to sense robot and effector movement thereto between cycles of assembly. Often times the compensation requires more than one cycle of assembly to permit sufficient movement and sensing of the robot effector location to detect the robot calibration necessary.

Prior art patents noted during an investigation conducted in connection with the present invention include U.S. Pat. Nos. 4,841,460 Dewar et al.; 6,166,811 Long et al.; 6,321,137 De Smet; 6,408,252 De Smet; 6,434,449 De Smet and 7,143,494 Savoy.

### SUMMARY OF THE INVENTION

One object of the present invention is to provides an improved system for cyclical robot temperature calibration in connection with vehicle body assembly.

In carrying out the above object, a system for cyclical robotic vehicle body assembly with robot temperature calibration in accordance with the invention includes a robot having an arm for mounting an end effector capable of operating on a positioned vehicle body workpiece and having a positioning target. A controller of the system initially operates the robot so its arm positions the end effector immediately adjacent the vehicle body workpiece in an almost ready work position in preparation for each cycle of operation. A laser sensor senses the location of the positioning target on the end effector in the almost ready work position and generates a position signal the controller uses to operate the robot and move its arm and the end effector thereon to a final temperature compensated work position for operation on the vehicle body workpiece in a temperature calibrated manner.

As disclosed, the system also includes at least one sensor, and preferably a plurality of sensors, for locating the vehicle body workpiece and generating a signal used by the controller to operate the robot in positioning the end effector.

The system as disclosed also includes another robot and another laser sensor operated by the controller in the same manner as the first mentioned robot and laser sensor to provide temperature compensated robot end effector positioning in a temperature calibrated manner.

Another object of the present invention is to provide a method for cyclical temperature calibration in connection with vehicle body assembly.

In carrying out the immediately preceding object, the method for cyclically operating a robot in accordance with the invention in a temperature calibrated manner in connection with vehicle body assembly is performed by operating a robot having an arm mounting an end effector to position the end effector and a target thereon in an almost ready work position immediately adjacent a vehicle body workpiece to initiate a cycle of operation. A laser senses the location of the positioning target on the end effector and generating a position signal used to operate the robot and move the end effector to a final temperature compensated work position for operation on the vehicle body workpiece in a temperature calibrated manner.

As disclosed, the position of the workpiece is initially sensed, preferably by a plurality of laser sensors, to initially operate the robot for positioning in the almost ready work position before the temperature calibration.

The method for a robot operation in a temperature calibrated manner in connection with vehicle body assembly as disclosed also operates another robot in cooperation with another laser sensor in the same manner as the first mentioned robot and laser sensor to provide further temperature compensated robot end effector positioning in a temperature calibrated manner.

### BRIEF DESCRIPTION OF THE DRAWINGS

FIG. 1 shows a system for robot temperature calibration using a laser sensor to cyclically read a target on the robot end effector while located adjacent the workpiece to establish the robot location in connection with vehicle body assembly.

FIG. 2 illustrates the robot end effector in an almost ready work position adjacent the workpiece in preparation for temperature calibration.

FIG. 3 illustrates the robot end effector after movement from the almost ready work position of FIG. 2 to a final work position for a cycle of operation that is calibrated for temperature.

FIG. 4 illustrates the workpiece after being formed in preparation for vehicle assembly.

### DETAILED DESCRIPTION OF THE PREFERRED EMBODIMENT

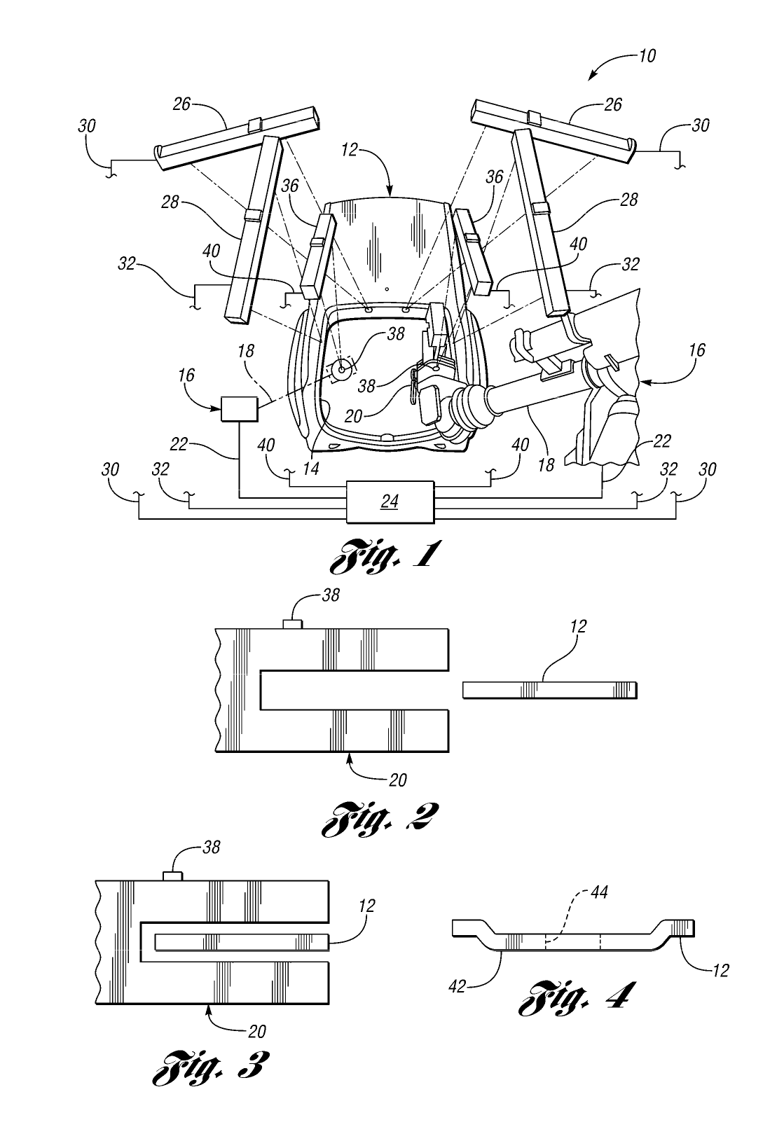

With reference to FIG. 1 of the drawings, a system for performing robot temperature calibration in connection with cyclical vehicle body assembly according to the invention is generally indicated by 10 and also performs the method of the invention, both of which will be described in an integrated manner to facilitate an understanding of all aspects of the invention.

With continuing reference to FIG. 1, a vehicle body workpiece 12 defines a rear hatch opening 14 and is operated upon to provide properly located mounting of an unshown rear hatch member. The vehicle body workpiece 12 is positioned by an assembly line in any conventional manner. System 10 as shown includes a pair of robots 16, one of which is illustrated schematically, whose arms 18 each have an end effector 20. Each robot 16 has a connection 22 to a controller 24 of the system. A pair of workpiece laser sensors 26 and 28 of the system 10 as shown are operable to sense the vehicle body location and have respective connections 30 and 32 to the controller 24.

A temperature calibration laser position sensor 36 associated with each robot initially senses the position of a target 38 on the robot end effector 20 in an almost ready work position shown in FIG. 2 immediately adjacent the workpiece 12. More specifically, the target 38 is on the robot arm past its last axis of the movement where the end effector is supported. The sensing generates a position signal to establish any temperature compensation needed in a longitudinal X, lateral Y, or vertical Z direction through a connection 40 to the controller 24.

Operation of the controller 24 shown in FIG. 1 permits each robot 16 to move its end effector 20 to compensate for temperature variations that may be present, such as the vertical upward shifting shown in FIG. 2 with respect to the workpiece 12. The robot then moves the end effector 20 to the a temperature compensated final work position of FIG. 3 to perform its assigned task on the workpiece 12 in a temperature calibrated manner. As shown in FIG. 4, the operation provides a mounting positioning pad 42 at the proper location and pierces an assembly hole 44 such as to facilitate mounting of the vehicle hatch member associated with the opening 14. With such temperature compensation at each cycle, the operation can be performed and maintained within a tolerance range of +/−0.5 mm.

It should be appreciated that other types of end effectors can also use this temperature calibrated operation with single as well as multiple workpieces, such as welding or assembly with fasteners, etc.

A prior art temperature compensation system is set up where the calibration stands are located between the robot and a safety fence, resulting in wide fence lines, while the present system does not require calibration stands and thus will have no impact to fence lines.

Prior temperature compensation systems are set up to be initiated during blocked and starved situations, which creates partial readings and intermittent temperature compensation adjustments and start up procedures. The present system provides complete “on the fly” temperature compensation adjustments with no added start up procedures.

Prior temperature compensation systems are placed 180 degrees away from the work position of the robot, and normally requires thirty-two separate measurements at different robot positions. The present system requires only one measurement taken within the normal working path of the robot.

Prior temperature compensation systems is a completely different apparatus from that used for the vehicle body assembly, while the present system uses the same apparatus used for vehicle body assembly.

Prior temperature compensation system requires thirty-two separate measurements at different robot positions to make an adjustment, while the present system requires only one measurement to make an adjustment.

Prior temperature compensation systems require significant training because of their uniqueness to vehicle body assembly systems. The new solution would require no additional training, while the present system does.

The present calibration system is also less expensive than prior systems.

While an embodiment and practice of the invention have been illustrated and described, it is not intended that this embodiment and practice illustrate and describe all possible forms of the invention. Rather, the words used in the specification are words of description rather than limitation, and it is understood that various changes may be made without departing from the spirit and scope of the invention.

What is claimed is:

1. A system for cyclical robotic vehicle body assembly with robot temperature calibration, comprising:
a robot having an arm for mounting an end effector capable of operating on a positioned vehicle body workpiece and having a positioning target;
a controller for initially operating the robot so its arm positions the end effector immediately adjacent the vehicle body workpiece in an almost ready work position in preparation for each cycle of operation; and
a laser sensor for sensing the location of the positioning target on the end effector in the almost ready work position and generating a position signal the controller uses to operate the robot and move its arm and the end effector thereon to a final temperature compensated work position for operation on the vehicle body workpiece in a temperature calibrated manner.

2. A system for cyclical robotic vehicle body assembly with robot temperature calibration as in claim 1 further including at least one sensor for locating the vehicle body workpiece and generating a signal used by the controller to operate the robot in positioning the end effector.

3. A system for cyclical robotic vehicle body assembly with robot temperature calibration as in claim 1 further including a plurality of laser sensors for locating the vehicle body workpiece and generating a signal used by the controller to operate the robot in positioning the end effector.

4. A system as in claim 1 further including another robot and another laser sensor operated by the controller in the same manner as the first mentioned robot and laser sensor to provide temperature compensated robot and effector positioning in a temperature calibrated manner.

5. A method for cyclically operating a robot in a temperature calibrated manner in connection with vehicle body assembly, comprising:
operating a robot having an arm mounting an end effector to position the end effector and a target thereon in an almost ready work position immediately adjacent a vehicle body workpiece to initiate a cycle of operation; and
laser sensing the location of the positioning target on the end effector and generating a position signal used to operate the robot and move the end effector to a final temperature compensated work position for operation on the vehicle body workpiece in a temperature calibrated manner.

6. A method for cyclically operating a robot in a temperature calibrated manner in connection with vehicle body assembly as in claim 5 wherein the position of the workpiece is initially sensed to initially operate the robot for positioning in the almost ready work position before the temperature calibration.

7. A method for cyclically operating a robot in a temperature calibrated manner in connection with vehicle body assembly as in claim 5 wherein the position of the workpiece is initially sensed by a plurality of laser sensors to initially operate the robot for positioning in the almost ready work position before the temperature calibration.

8. A method for robot operation in a temperature calibrated manner in connection with vehicle body assembly as in claim 5 that operates another robot in cooperation with another laser sensor in the same manner as the first mentioned robot and laser sensor to provide further temperature compensated robot end effector positioning in a temperature calibrated manner.
